(19) United States
(12) Patent Application Publication
(10) Pub. No.: US 2022/0248910 A1
(43) Pub. Date: Aug. 11, 2022

(54) MIXER UNIT FOR FOODSTUFFS

(71) Applicant: POLITECNICO DI MILANO, Milano (IT)

(72) Inventors: Giuseppe FAZIO, Bari (IT); Sofia SECCHI, Bibbiano (IT); Nicola BESANA, Bergamo (IT)

(21) Appl. No.: 17/617,763

(22) PCT Filed: Jun. 11, 2020
(86) PCT No.: PCT/IB2020/055491

§ 371 Date: Dec. 9, 2021

(30) Foreign Application Priority Data
Jun. 13, 2019 (IT) 102019000008925

(51) Int. Cl. A47J 43/07; A47J 43/046

(52) U.S. Cl. CPC A47J 43/0766; A47J 43/0722; A47J 43/046

(57) ABSTRACT

A mixer unit suitable for whipping and mixing solid and/or liquid foodstuffs, comprises a base portion containing a motor, a container suitable for receiving a desired dose of foodstuffs to be processed and shaped for being rested, in an upturned position, on a surface placed above said base portion; the mixer unit further comprises a retractable blade unit to whip and mix the solid and liquid foodstuffs directly inside the container, the retractable blade unit being movable from a retracted non-operating configuration to an extended operating configuration for processing the foodstuffs directly inside the container, the container being provided with removable closing and coupling elements, configured for sealingly coupling, partially with the surface and partially with the retractable blade unit, so as to permit the positioning and rotation of the retractable blade unit inside the volume bounded by the container.

### CROSS-REFERENCE TO RELATED APPLICATIONS

This application claims priority of PCT/IB2020/055491, filed Jun. 11, 2020. Application No. PCT/IB2020/055491 claims priority of IT102019000008925, filed Jun. 13, 2019. The entire content of these applications is incorporated herein by reference.

### BACKGROUND OF THE INVENTION

The invention relates to a mixer unit for solid and/or liquid foodstuffs for preparing beverages, shakes, milkshakes and the like.

### PRIOR ART

The use of mixers for foodstuffs has been known for some time.

One example is provided by what has been disclosed in the US document US2007/0109913 A1 entitled “Method and apparatus for preparing beverages”.

However, such mixers have drawbacks. They usually have blade units arranged in such a way as to be accessible to a user and are therefore not completely safe. During operation, a user could accidentally reach the blades, thus getting injured. This could occur during the blades cleaning step.

Such mixers do not include self-cleaning of the blades, for example dry cleaning, and have a large number of elements to be cleaned once use has finished.

The need for a shutdown for cleaning means that these mixers are not always ready for use.

After each preparation, the components have to be cleaned, especially the blades and the food collection tank. This entails lengthy periods for the consecutive preparation of several portions.

Further, by using such mixers, it is not that easy to obtain the desired quantity of end product.

Such devices are structurally and functionally rather complex, unsatisfactory from the economic point of view and, operationally, require frequent cleaning and maintenance that is also not easy and fast to perform.

Other mixing devices are known from WO2018/134573, U.S. Pat. No. 4,872,764, DE102010060094.

### SHORT DESCRIPTION OF THE INVENTION

This object is achieved by a mixer unit according to what has been claimed.

Owing to this mixer unit, it is possible to increase the speed in the consecutive production of the products. Between the preparation of one product and the other, it is not necessary to stop or dismantle the mixer unit.

Further, owing to the invention, the user never comes into contact with the blades, not even during the cleaning of the blades, significantly increasing safety and avoiding accidental wounds.

The blades are dry cleaned, inside the mixer unit, also owing to the coating of the blades that is made of water-repellent and hydrophic material, according to one possible embodiment of the mixer unit. This enables the number of components to be reduced that have to be washed after every preparation cycle. Fine cleaning of the mixer unit can occur after a large number of consecutive preparation cycles, or after numerous consecutive dry-cleaning cycles.

Owing to the fact that the mixing action occurs directly inside the container in which the blade unit is positioned, the preparation of the foodstuff to be consumed is immediate and very easy, thus minimizing the operations of transferring the foodstuffs from one container to the other.

### BRIEF DESCRIPTION OF THE DRAWINGS

In order to better understand the invention, a description is given below of an embodiment by way of non-limiting example, illustrated in the attached drawings in which:

FIG. 1 is an exploded view of a mixer unit according to the invention;

FIG. 2 shows an exploded view of a blades unit in FIG. 1;

FIG. 3 shows an exploded view of a lid in FIG. 1;

FIG. 4 shows in section the mixer unit of FIG. 1, in a first operating position;

FIG. 5 shows in section the mixer unit of FIG. 1, in a second operating position;

FIG. 6 shows in section the mixer unit of FIG. 1, in a third operating position;

FIG. 7 shows in section the mixer unit of FIG. 1, in a fourth operating position.

### DETAILED DESCRIPTION OF THE INVENTION

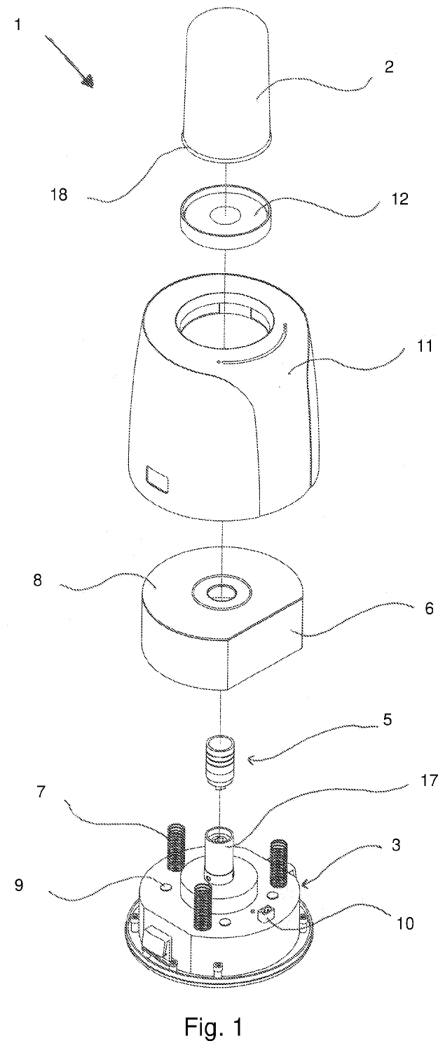

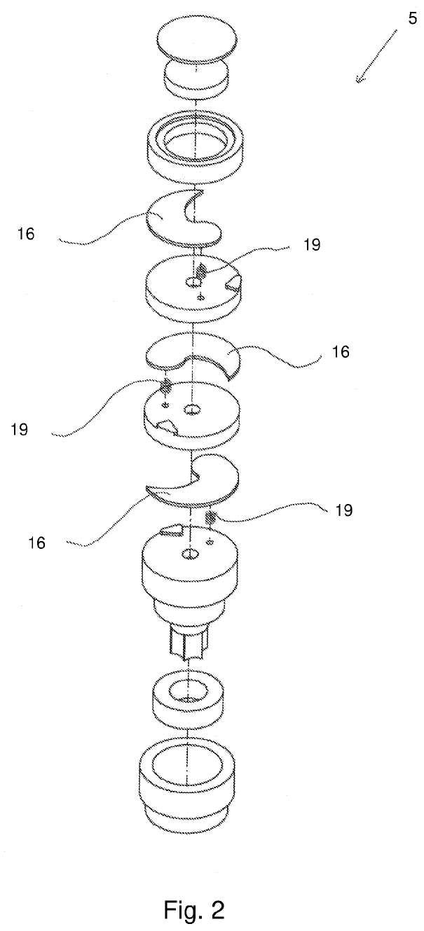

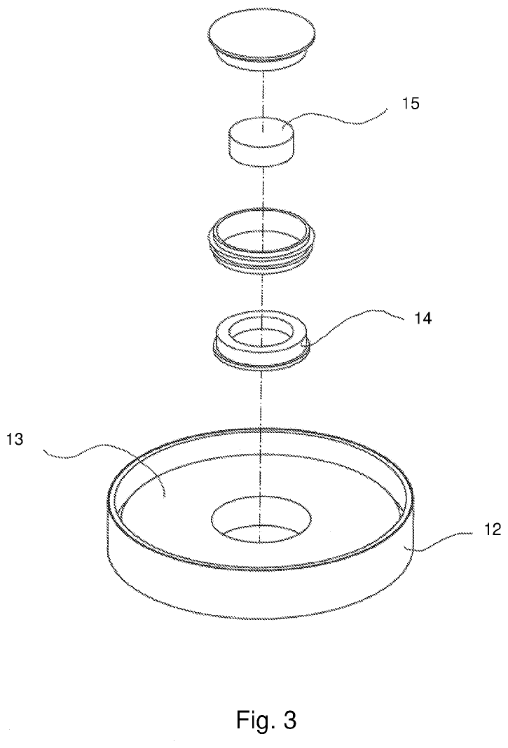

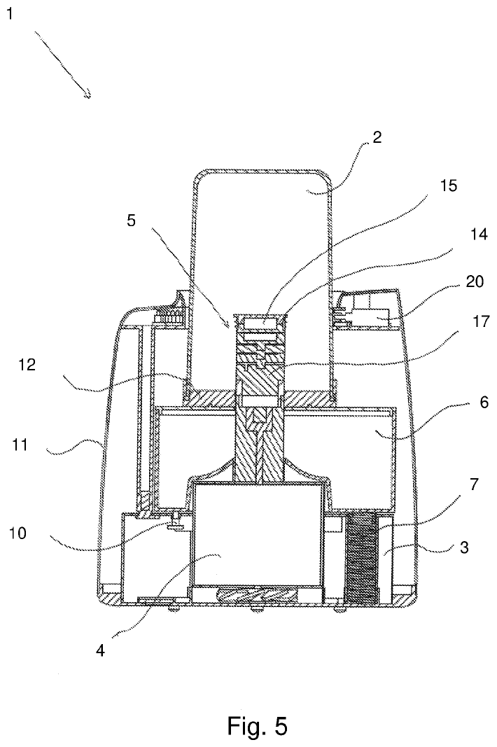

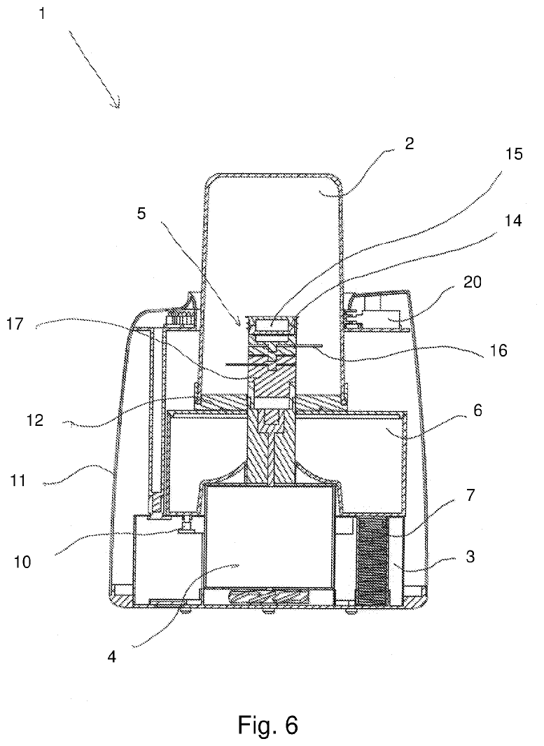

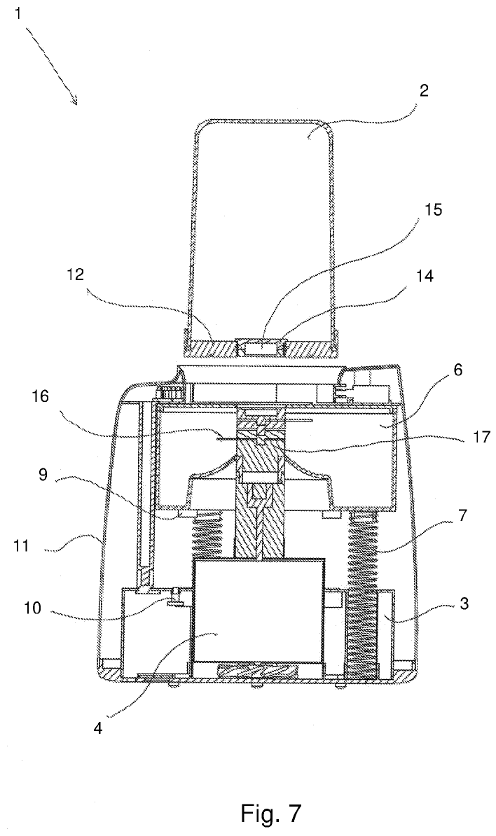

With reference to FIGS. 1 to 7, a mixer unit 1 for foodstuffs is illustrated, indicated generically with 1. In particular, the mixer unit 1, is used for making fruit and/or vegetable juices.

This mixer unit 1 comprises a base portion 3 that is suitable for housing a motor 4. The motor 4 can be of “brushless” type. The base portion 3 is the part of the mixer unit 1 intended to rest on a flat work surface, for example of a kitchen. The base portion 3 is covered by an intermediate case.

The mixer unit 1 further comprises a retractable blade unit 5, 16 that is mechanically connected to the, and rotatable by the motor 4, to whip and mix the solid and/or liquid foodstuffs directly inside the container 2. The blade unit 5, 16 is housed in a metal cylindrical element 17. The retractable blade unit 5, 16 is movable from a retracted non-operating configuration to an extended operating configuration for processing the foodstuffs directly inside the container 2. The blade unit 5, 16 consists of blades 16 arranged on several levels; in other words, the blades 16 are distributed on several mutually distanced and parallel planes, in particular horizontal lie planes; such blades 16, in the retracted position, are received and enclosed in slots of the aforesaid cylindrical element 17 that is dismantlable and washable; the blades 16 open, i.e. they are arranged in an extended position, by a centrifugal effect due to the rotation of the cylindrical element 17 and they are mechanically reclosed owing to the return action exerted by suitable springs 19, for example harmonic springs, as soon as the motor 4 is stopped. The blades have a concavity facing the axis of the cylindrical element 17 and the part intended for cutting that is in the convex part. The number of blades 16 can be the same as or greater than 2, in particular equal to 3. The blades are made of water-repellent and/or oil-repellent material. This material permits dry cleaning of the blades, which is exploited only by the centrifugal force of the blades. In fact, the stainless steel blades 16 undergo a surface coating treatment that makes them completely water-repellent and oil-repellent. This treatment comprises silicone surface treatment, which is then suitable for food use. Owing to his configuration, it is possible to resort to a second cleaning step for cleaning the single components with water and detergent, in dishwashers or by hand also after a long series of use cycles, without compromising operating efficacy and the requested hygiene levels.

The mixer unit 1 further comprises a waste collecting tank 6 that rests on the base portion 3 by means of springs 7; the lid 8 of the waste collecting tank 6 acts as a rest for a container 2 during the moments of use of the mixer unit 1. At least two springs 7 are provided. In a possible embodiment, three springs 7 are provided. The waste collecting tank 6 is movable between a first rest position in which the container 2 is merely rested on the surface 8, a second position corresponding to a lowering of the container 2 and thus of the waste collecting tank 6 until it comes into contact with said electromagnets 9 and a third position corresponding to a further lowering of the container 2 and thus of the waste collecting tank 6 until it comes into contact with said switch 10 for switching on/switching off the motor 4. The waste collecting tank 6 runs along the blade unit 5, 16. The blade unit 5, 16 remains longitudinally stationary. The blades 16 rotate clockwise, i.e. with the concave part active in the cutting action. As already mentioned, the blades 16 are covered with a water-repellent/oil-repellent material to encourage dry-cleaning by centrifugal force due to the rotation of the blades.

The container 2, which is typically made of glass, is suitable for receiving a desired dose of foodstuffs to be processed and is shaped for being rested, in an upturned position, on a surface 8 placed above the base portion 3. The container 2 is provided with removable closing and coupling elements 12, 13, 14, 15, configured for sealingly coupling, partially with the surface 8 and partially with the retractable blade unit 5, 16, so as to permit the positioning and rotation of the retractable blade unit 5, 16 inside the volume bounded by the container 2. The container 2 thus comprises magnetic lid 12. This lid is made of polymeric material. This lid 12 consists of two portions. A first circular crown portion 13 that connects to the upper edge 18 of the glass, and an inner second circular portion 14 that is coaxial with the first portion 13, that contains a magnet 15 that is suitable for being coupled magnetically with the blade unit 5, 16, detaching from the first portion 13 and enabling the blade unit 5, 16 to enter the container 2. The second portion 14 is provided with gaskets. The lid 12 and thus the container 2, thus like the waste collecting tank 6, slide along the blade unit 5, 16. The first 13 and the second 14 portion of the lid 12 are so coupled by seal-type interference that, in the reciprocal coupling position, any leak of liquids and thus escapes from the container 2 is prevented. The two portions are decoupled at the moment in which the container is pushed downwards to proceed with the mixing action. The two portions couple with one another again when the container 2 is removed from the blade unit 5, 16, i.e. by pulling the container 2 upwards. In the period in which the two portions 13, 14 are uncoupled, the absence of leaks results from the tight seal between the inner part of the first portion 13 and the outer surface of the cylindrical element 17 supporting the blades 16.

Electromagnets 9 positioned on the base portion 3 are suitable for locking the container 2 when it is pressed against the lid 8 of the tank 6. In particular, the electromagnets 9 lock the waste collecting tank 6 in contact with the base portion 3 and consequently also the container 2 with the outer casing 11. On the base portion 3, a switch 10 is also positioned for switching on/switching off the motor 4. The container 2 is pushed downwards by dragging with it the waste collecting tank 6 that slides around the blade unit 5, 16 and compresses the springs 7. The descent ends when the waste collecting tank 6 reaches the electromagnets 9 and is then connected. A further thrust of the container 2 enables the container 2 to perform a further stroke, forcing the waste collecting tank 6 to compress further the springs 7 and to drive the switch 10 for switching on/switching off the motor 4. The switch 10 for switching on/switching off is then activated by the contact with the waste collecting tank 6. Thus, the blade unit 5, 16 is in operation when the container 2 is pressed to the bottom of the stroke of the waste collecting tank 6. When the container 2 no longer exerts pressure on the waste collecting tank 6, after a certain lapse of time the electromagnets 9 leave the waste collecting tank 6 that is free to ascend, also helped by the compressed springs 7. Such springs 7 have to be sufficiently stiff to permit a rapid re-ascent of the container 2 to enable the lid 12, namely the inner second circular portion 14, to reclose during the re-ascent, avoiding an escape of liquid.

Further, the mixer unit 1 also comprises an outer casing 11 that snaps onto the base portion 3 that is suitable for containing all the elements disclosed above apart from only the container 2 with lid 12. The outer casing 11 further contributes to giving a pleasing appearance to the mixer unit 1. On the edge of the hole of the outer casing 11 there are linear actuators 20 that act as pushers. In fact, they tend to push on the edge of the container 2 when it is positioned, through the hole, on the lid 8 of the waste collecting tank. In such a manner the container 2 is prevented from being able to exit from the seat during the mixing operations.

The flat surface of the lid 8 of the tank permits amongst other things easy first positioning of the container 2.

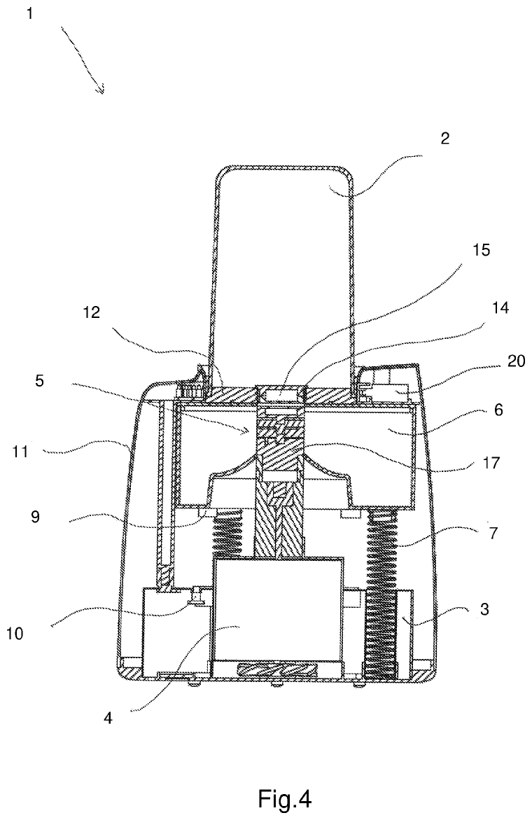

From the operational point of view, functioning occurs according to what is shown in FIGS. 4-7. In particular, a user takes the container 2 and fills the container 2 with foodstuffs, for example fruit. Once the operation has finished, the user closes the container 2 with the suitable lid 12. At this point, the operator has to overturn the container 2 until the lid 12 of the container 2 is placed on the lid 8 of the tank, following the guide hole in the outer casing 11. At this point, the user presses the container 2 downwards, exerting a force that compresses the springs 7 positioned between the tank 6 and the base portion 3. The cylindrical element 17 containing the blade unit 5,16 penetrates progressively into the container 2 at the second portion 14 of lid 12 of the container 2, which in the meantime has detached itself from the first circular crown portion 13 and has adhered magnetically to the circular surface of the containing cylindrical element 17. This is the position in which the container 2 is full of foodstuffs and the blades 16 are ready for being driven. The user presses downwards the container 2 by another quantity that is necessary and sufficient to press the switch 10 and to press the motor 4, which drags the cylindrical element 17 and thus drives the blades 16. The blades 16 reach a certain maximum opening beyond which they cannot move because of a mechanical stop.

When the user finishes applying pressure to the container 2 and thus to the switch 10, the motor 4 stops, the cylindrical element 17 stops and consequently the blades 16, through the cessation of the centrifugal effect, retract, recalled by the relative springs. By releasing further the container 2 and thus removing the container 2 from the lid 8 of the tank 6 owing to the thrust of the compressed springs 7, the first circular crown portion 13 of the lid 12 of the container 2 slides along the cylindrical element 17 supporting the blades 16 until meeting the second portion 14, which is magnetically constrained on the cylindrical element 17 supporting the blades 16. When the two portions 13, 14 come into contact with each other, the lid 12 is entirely recomposed, performing effectively the function of preventing the compound contained in the container 2 from being lost. In other words, the blade unit 5, 16 penetrates and is extracted from the lid 12 without any leak of liquids from the container 2. When the container 2 is completely separated, the system automatically drives the blade unit 5, 16 for a few seconds to perform dry cleaning. In this step, the blade unit 5, 16 is contained entirely in the waste collecting tank 6. The rotation of the blades 16 projects the residues against the walls of the waste collecting tank 6. During this cleaning step, the linear actuators 20 are active being pushed to the axis of the mixer unit 1 to prevent a container 2 being possibly accidentally positioned with the blade unit 5, 16 operating.

Dry cleaning of the blades 16 occurs automatically. In particular, once the container 2 has been extracted and removed from the mixer unit 1, the blade unit 5, 16 is activated for a few seconds to perform cleaning with only centrifugal force, inside the waste collecting tank 6. In this manner, the residue is collected in the waste collecting tank 6. The blade unit 5, 16 operates only when it is completely included in the container 2 or in the waste collecting tank 6, so there are no corresponding rotations between the blade unit 5, 16 and the container 2 or between the blade unit 5, 16 and tank 6 because the ends of the dismantlable cylindrical element 17 that are in contact with the container 2 or tank 6, are stationary and not rotating correspondingly.

From what has been disclosed and illustrated with the help of the enclosed figures, it is clear that the mixer unit 1 is simple and easy to use.

Another advantage is that the mixer unit 1 operates in a reliable and intuitive manner.

A further advantage is that the mixer unit 1 is constructionally simple and cheap.

A further advantage is that the mixer unit 1 is structurally more solid than known mixer units and is accordingly able to support better mechanical and thermal stress due to repeated use.

A still further advantage is that the mixer unit 1 is easy and quick to clean and maintain.

Still another advantage is that the user never comes into contact with the blades 16 and thus the system ensures greater safety than do mixers of the prior art.

Obviously, variations on and/or additions to what has been disclosed and illustrated can be envisaged.

For example, the geometry and in general the configuration of the various elements that make up the mixer unit 1, like the outer casing 11, the base portion 3, the waste collecting tank 6 and blade unit 5, 16, the container 2 and the lid 12 of the container 2 can be different from what has been disclosed and illustrated.

1. A mixer unit suitable for blending and mixing solid and liquid foodstuffs, comprises:
a base portion containing a motor,
a container suitable for receiving a desired dose of foodstuffs to be processed and shaped for being rested, in an upturned position, on a surface placed above said base portion;
a retractable blade unit, which is rotatable by said motor, to blend and mix said solid and liquid foodstuffs directly inside said container,
said retractable blade unit being movable from a retracted non-operating configuration to an extended operating configuration for processing the foodstuffs directly inside said container,
said container being provided with removable closing and coupling means elements, configured for sealingly coupling, partially with said surface and partially with said retractable blade unit, so as to permit the positioning and rotation of said retractable blade unit inside the volume bounded by said container,
a waste collecting tank that rests on said base portion by means of springs, said tank having a lid acting as a support surface for the container,
electromagnets positioned on the base portion that are suitable for locking the container when it is pressed against the lid of the waste collecting tank,
a switch for switching on/switching off the motor located on the base portion,
an outer casing that snaps onto the base portion to contain all the components listed above.

2. A mixer unit according to claim 1, wherein said waste collecting tank is movable.

3. A mixer unit according to claim 1, wherein the waste collecting tank is movable between a first rest position in which the container is merely rested on the surface, a second position corresponding to a lowering of the container and thus of the waste collecting tank until it comes into contact with said electromagnets and a third position corresponding to a further lowering of the container and thus of the waste collecting tank until it comes into contact with said switch for switching on/switching off the motor.

4. A mixer unit according to claim 1, wherein said container is a glass comprising a magnetic lid for the glass, said lid consisting of a first circular crown portion, that hooks to the upper edge of the glass, and a second circular portion, which is internal to, and coaxial with said first circular crown portion and contains a magnet, which couples magnetically with the blade unit, detaching from said first portion and enabling the blade unit to enter the glass.

5. A mixer unit according to claim 4, wherein said first portion and said second portion are coupled by seal-type interference, such that when there is the coupling there is no leak of liquids, and thus escapes, from the container.

6. A mixer unit according to claim 1, wherein the blade unit comprises a plurality of blades arranged on several levels.

7. A mixer unit according to claim 6, wherein the aforesaid blades are enclosed in slots obtained in a cylindrical element, that is dismantlable and washable, said blades being configured for opening owing to the centrifugal force generated by the rotation of said cylindrical element and for reclosing by return springs, when the motor stops.

8. A mixer unit according to claim 7, wherein said springs for closing the blades are of harmonic type.

9. A mixer unit according to claim 1, wherein said blade unit is made of a water-repellent and/or oil-repellent material.

10. A mixer unit according to claim 1, wherein said springs on which the waste collecting tank rests, are at least two.

11. A mixer unit according to claim 1, wherein the switch for switching on/switching off is activated by the contact with the waste collecting tank.

12. A mixer unit according to claim 1, wherein said blades are made of stainless steel and are provided with a protective silicon surface coating that confers water-repellent and/or oil-repellent properties.

13. A mixer unit according to claim 1, wherein linear actuators act as pushers acting on the edge of the container when it is positioned on the lid of the waste collecting tank.
